(19) United States
(12) Patent Application Publication
(10) Pub. No.: US 2019/0285534 A1
(43) Pub. Date: Sep. 19, 2019

(54) PARTICULATE DETECTOR

(71) Applicant: NGK INSULATORS, LTD., Nagoya-City (JP)

(72) Inventors: Hidemasa OKUMURA, Nagoya-City (JP); Keiichi KANNO, Nagoya-City (JP); Kazuyuki MIZUNO, Nagoya-City (JP)

(73) Assignee: NGK INSULATORS, LTD., Nagoya-City (JP)

(21) Appl. No.: 16/299,681

(22) Filed: Mar. 12, 2019

(30) Foreign Application Priority Data
Mar. 19, 2018 (JP) 2018-051051

(51) Int. Cl. G01N 15/06

(52) U.S. Cl. CPC G01N 15/0656; G01N 2015/0046; G01N 15/0606

(57) ABSTRACT

A particulate detector is used to detect particulates in gas. The particulate detector includes a housing, an electric-charge generator, a collector, a noise canceller, and a number detection unit. The housing has a gas flow path through which the gas passes. The electric-charge generator applies electric charges generated by electric discharge to the particulates in the gas that is introduced into the gas flow path to obtain charged particulates. The collector is disposed on the gas flow path downstream of the electric-charge generator in a direction of flow of the gas and collects the charged particulates. The noise canceller cancels a noise that is made due to the electric discharge of the electric-charge generator. The number detection unit detects the number of the particulates on the basis of a physical quantity that varies in response to the charged particulates collected by the collector.

### BACKGROUND OF THE INVENTION

### 1. Field of the Invention

The present invention relates to a particulate detector.

### 2. Description of the Related Art

A known particulate detector generates ions by corona discharge of an electric-charge-generating element, charges particulates in a measurement gas by using the ions to obtain charged particulates, collects the charged particulates by using a collect electrode, and measures the number of the particulates on the basis of the quantity of electric charge of the collected charged particulates (see, for example, PTL 1).

### CITATION LIST

### Patent Literature

PTL 1: International Publication No. 2015/146456

### SUMMARY OF THE INVENTION

However, the quantity of the electric charge of the charged particulates collected by the collect electrode is tiny and is likely to be affected by a noise, and it is difficult to detect the quantity of the electric charge with high precision.

The present invention has been accomplished to solve the above problem, and a primary object of the present invention is to increase the accuracy of detection of the amount of the particulates.

### Solution to Problem

According to the present invention, the following measure is taken to achieve the above primary object.

A particulate detector that is used to detect a particulate in gas according to the present invention, the particulate detector includes:

a housing having a gas flow path through which the gas passes;

an electric-charge generator that applies an electric charge generated by electric discharge to the particulate in the gas that is introduced into the gas flow path to obtain a charged particulate;

a collector that is disposed on the gas flow path downstream of the electric-charge generator in a direction of flow of the gas and that collects, as an object to be collected, the charged particulate or an excess electric charge that is not applied to the particulate;

a noise canceller that cancels a noise that is made due to the electric discharge of the electric-charge generator; and

a detection unit that detects an amount of the particulate on the basis of a physical quantity that varies in response to the object collected by the collector.

In the particulate detector, the electric-charge generator generates the electric charge to obtain the charged particulate from the particulate in the gas, and the collector collects, as the object to be collected, the charged particulate or the excess electric charge. The detection unit detects the amount of the particulate on the basis of the physical quantity that varies in response to the object collected by the collector. The noise canceller cancels the noise that is made due to the electric discharge of the electric-charge generator. Such a noise affects the physical quantity that varies in response to the object collected by the collector, but is canceled here by the noise canceller. Consequently, the physical quantity that varies in response to the object collected by the collector can be grasped with high precision, and hence, the accuracy of the detection of the amount of the particulate can be increased.

In the description, the “electric charge” includes an ion in addition to a positive electric charge and a negative electric charge. The “physical quantity” may be a parameter that varies depending on the object to be collected, and an example thereof includes an electric current. Examples of the “amount of the particulate” include the number, mass, surface area of the particulate.

In the particulate detector according to the present invention, a sinusoidal voltage or a pulse voltage for the electric discharge may be applied to the electric-charge generator, and a sinusoidal voltage or a pulse voltage that has a polarity opposite a polarity of the sinusoidal voltage or the pulse voltage may be applied to the noise canceller. This enables the noise that is made due to the electric discharge of the electric-charge generator to be effectively canceled. The sinusoidal voltage or the pulse voltage that has the opposite polarity and that is applied to the noise canceller preferably has the same phase as the sinusoidal voltage or the pulse voltage that is applied to the electric-charge generator.

In the particulate detector according to the present invention, the noise canceller may be disposed between the electric-charge generator and the collector. In this case, the noise canceller can be disposed near the collector, and the noise can be canceled by using a voltage that has a relatively small absolute value. In some cases, an electric charge that has the polarity opposite the polarity of the electric charge generated by the electric-charge generator is generated by electric discharge of the noise canceller. However, since the absolute value of the voltage that is applied to the noise canceller can be decreased, the quantity of the generated electric charge that has the opposite polarity decreases accordingly. Consequently, the electric charge of the charged particulate can be inhibited from being canceled by the electric charge that has the opposite polarity and that is generated by the noise canceller before the charged particulate is collected by the collector.

In the particulate detector according to the present invention, the noise canceller may be disposed so as to face the electric-charge generator. This enables the length of the gas flow path to be shorter than that in the case where the noise canceller is disposed on the same surface as the electric-charge generator.

In the particulate detector according to the present invention, the noise canceller may be disposed downstream of the collector in the direction of the flow of the gas. In this case, the electric charge of the charged particulate is scarcely canceled by the electric charge that has the opposite polarity and that is generated by the noise canceller before the charged particulate is collected by the collector.

In the particulate detector according to the present invention, the collector may collect the charged particulate as the object to be collected, and an excess-electric-charge-removing unit that removes the excess electric charge may be disposed between the electric-charge generator and the collector. This inhibits the collector from collecting the excess electric charge, and the accuracy of the detection of the amount of the particulate increases.

### BRIEF DESCRIPTION OF THE DRAWINGS

FIG. 1 illustrates a particulate detector 10.

FIG. 2 is a perspective view of a particulate-detecting element 20.

FIG. 3 is a sectional view of FIG. 2 taken along line A-A.

FIG. 4 is a sectional view of FIG. 2 taken along line B-B.

FIG. 5 is a graph illustrating variations in electrical signals of electrodes 32, 92, and 54 over time.

FIG. 6 is a graph illustrating the variations in the electrical signals of the electrodes 32, 92, and 54 over time.

FIG. 7 is a sectional view of a particulate detector 110.

FIG. 8 is a sectional view of a particulate detector 210.

FIGS. 9A to 9G illustrate representative examples of the shapes of a pulse voltage and a sinusoidal voltage.

### DETAILED DESCRIPTION OF THE INVENTION

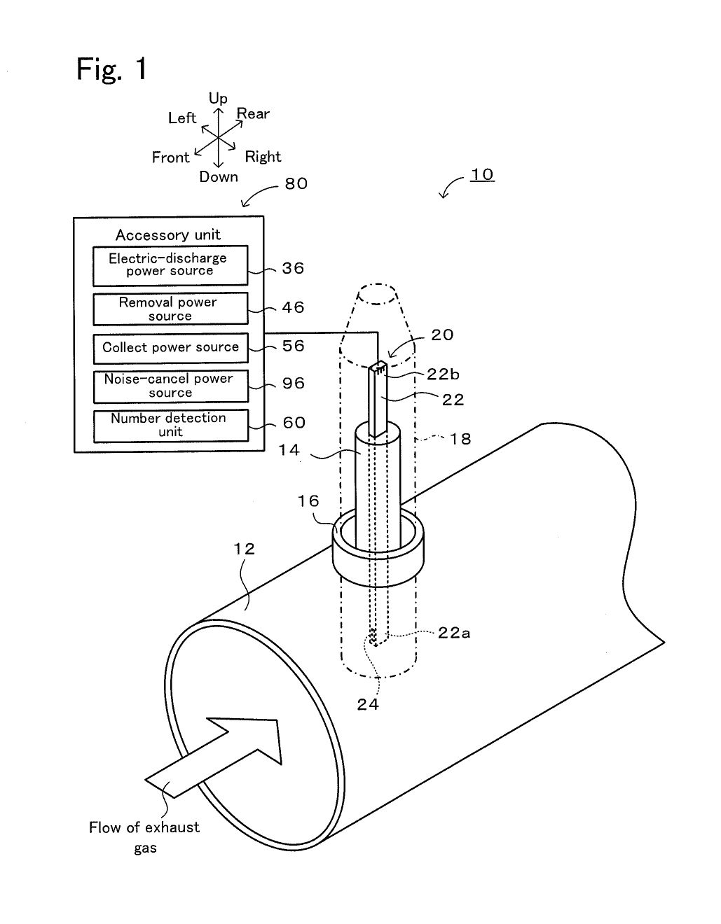

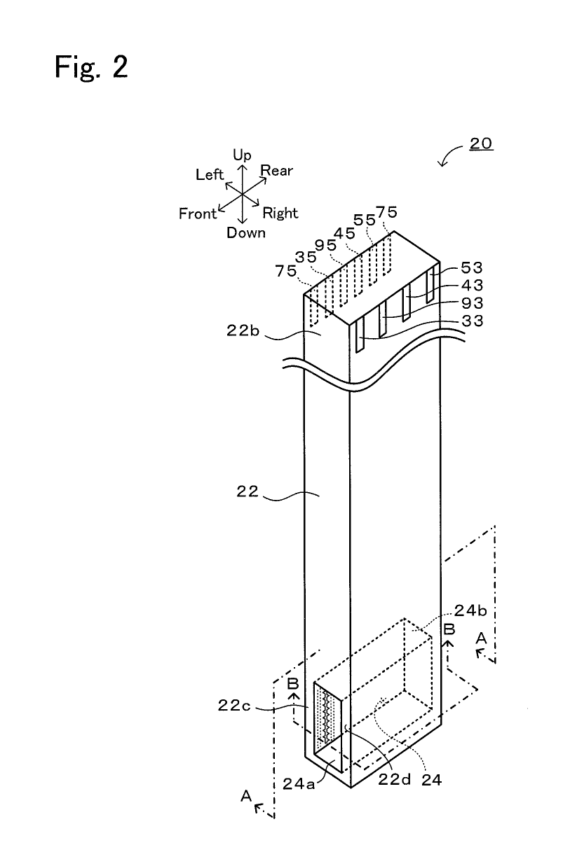

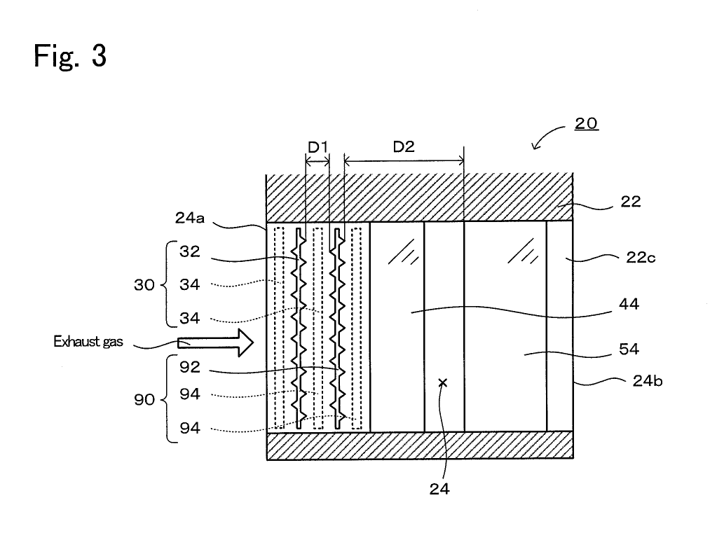

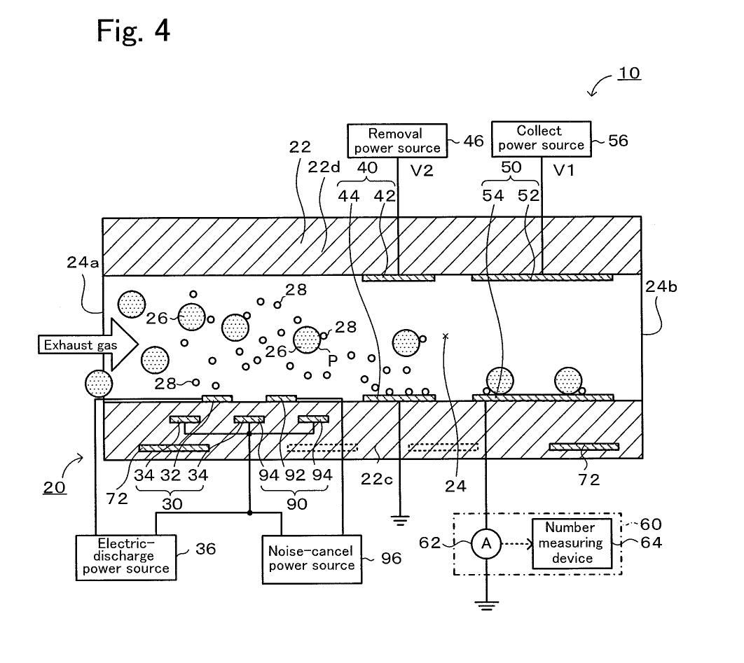

An embodiment of the present invention will now be described with reference to the drawings. FIG. 1 illustrates a particulate detector 10 according to the embodiment of the present invention. FIG. 2 is a perspective view of a particulate-detecting element 20. FIG. 3 is a sectional view of FIG. 2 taken along line A-A. FIG. 4 is a sectional view of FIG. 2 taken along line B-B. According to the embodiment, a vertical direction, a left-right direction, and a front-rear direction coincide with those illustrated in FIG. 1 to FIG. 2.

As illustrated in FIG. 1, the particulate detector 10 detects the number of particulates 26 (see FIG. 4) contained in exhaust gas that flows through an exhaust pipe 12 of an engine. The particulate detector 10 includes the particulate-detecting element 20 and accessory units 80 including various power sources 36, 46, 56, and 96 and a number detection unit 60.

As illustrated in FIG. 1, the particulate-detecting element 20 is inserted in a cylindrical support 14 and attached to a ring-shaped base 16 that is secured to the exhaust pipe 12. The particulate-detecting element 20 is protected by a protective cover 18. The protective cover 18 has a hole not illustrated. The exhaust gas that flows through the exhaust pipe 12 passes through the hole and a gas flow path 24 that a lower end portion of the particulate-detecting element 20 has. As illustrated in FIG. 4, the particulate-detecting element 20 includes an electric-charge generator 30, a noise canceller 90, an excess-electric-charge-removing unit 40, a collector 50, and a heater electrode 72 in a housing 22.

As illustrated in FIG. 1, the housing 22 has a rectangular cuboid shape elongated in a direction intersecting (substantially perpendicular to) the axial direction of the exhaust pipe 12. The housing 22 is an insulator and is composed of, for example, ceramics such as alumina. A lower end portion 22a of the housing 22 is located inside the exhaust pipe 12, and an upper end portion 22b thereof is located outside the exhaust pipe 12. The lower end portion 22a of the housing 22 has the gas flow path 24. Various terminals are disposed on the upper end portion 22b of the housing 22.

The axial direction of the gas flow path 24 coincides with the axial direction of the exhaust pipe 12. As illustrated in FIG. 2, the gas flow path 24 is a space having a rectangular cuboid shape extending from a rectangular gas inlet 24a formed in a front surface of the housing 22 to a rectangular gas outlet 24b formed in a rear surface of the housing 22. The housing 22 includes a pair of left and right flow path walls 22c and 22d that define the gas flow path 24.

As illustrated in FIG. 3 and FIG. 4, the electric-charge generator 30 is disposed in the flow path wall 22c such that an electric charge is generated near the gas inlet 24a inside the gas flow path 24. The electric-charge generator 30 includes an electric discharge electrode 32 and two ground electrodes 34. The electric discharge electrode 32 is disposed along the inner surface of the flow path wall 22c and has fine projections around a rectangle as illustrated in FIG. 3. The two ground electrodes 34 are rectangular electrodes and are embedded in the flow path wall 22c so as to be spaced from each other and be parallel to the electric discharge electrode 32. At the electric-charge generator 30, as illustrated in FIG. 4, a pulse voltage of several kV of an electric-discharge power source 36 (one of the accessory units 80) is applied between the electric discharge electrode 32 and the two ground electrodes 34, and consequently, air discharge occurs due to electric potential difference between the electrodes. At this time, a portion of the housing 22 between the electric discharge electrode 32 and the ground electrodes 34 functions as a dielectric layer. The air discharge ionizes gas around the electric discharge electrode 32, and positive electric charges 28 are generated. The electric discharge electrode 32 is connected to a terminal 33 (see FIG. 2) on the upper end portion 22b of the housing 22 with a wiring line that is disposed in the housing 22 and that is not illustrated interposed therebetween and is connected to the electric-discharge power source 36 with the terminal 33 interposed therebetween. The two ground electrodes 34 are connected to a terminal 35 (see FIG. 2) on the upper end portion 22b of the housing 22 with a wiring line that is disposed in the housing 22 and that is not illustrated interposed therebetween and are connected to the electric-discharge power source 36 with the terminal 35 interposed therebetween.

As illustrated in FIG. 4, the particulates 26 contained in the gas enter the gas flow path 24 from the gas inlet 24a, become charged particulates P when the particulates 26 pass through the electric-charge generator 30 and the electric charges 28 that are generated by the air discharge of the electric-charge generator 30 are applied thereto, and subsequently move backward. Of the electric charges 28 generated, some electric charges that are not applied to the particulates 26 do not change from the electric charges 28 and move backward as it is.

As illustrated in FIG. 3 and FIG. 4, the noise canceller 90 is disposed in the flow path wall 22c downstream of the electric-charge generator 30 (specifically, between the electric-charge generator 30 and a collect electrode 54, more specifically, between the electric-charge generator 30 and a removal electrode 44). The noise canceller 90 includes a noise cancel electrode 92 and two ground electrodes 94. The noise cancel electrode 92 is disposed along the inner surface of the flow path wall 22c and has fine projections around a rectangle as illustrated in FIG. 3. The two ground electrodes 94 are rectangular electrodes and are embedded in the flow path wall 22c so as to be spaced from each other and be parallel to the noise cancel electrode 92. Of the ground electrodes 94, the ground electrode 94 nearer to the electric-charge generator 30 doubles as one of the ground electrode 34 of the electric-charge generator 30. At the noise canceller 90, a pulse voltage of a noise-cancel power source 96 (one of the accessory units 80) is applied between the noise cancel electrode 92 and the two ground electrodes 94, and consequently, a noise that is made due to the electric discharge of the electric-charge generator 30 is canceled. Specifically, a pulse voltage that has the polarity opposite the polarity of the pulse voltage applied to the electric-charge generator 30 and that has the same phase or substantially the same phase as the pulse voltage applied to the electric-charge generator 30 is applied. The noise cancel electrode 92 is connected to a terminal 93 (see FIG. 2) on the upper end portion 22b of the housing 22 with a wiring line that is disposed in the housing 22 and that is not illustrated interposed therebetween and is connected to the noise-cancel power source 96 with the terminal 93 interposed therebetween. The two ground electrodes 94 are connected to a terminal 95 (see FIG. 2) on the upper end portion 22b of the housing 22 with a wiring line that is disposed in the housing 22 and that is not illustrated interposed therebetween and are connected to the noise-cancel power source 96 with the terminal 95 interposed therebetween.

As illustrated in FIG. 4, the excess-electric-charge-removing unit 40 is disposed downstream of the electric-charge generator 30 and upstream of the collector 50. The excess-electric-charge-removing unit 40 includes an application electrode 42 and the removal electrode 44. The application electrode 42 is disposed along the inner surface of the right flow path wall 22d and is exposed to the inside of the gas flow path 24. The removal electrode 44 is disposed along the inner surface of the left flow path wall 22c and is exposed to the inside of the gas flow path 24. The application electrode 42 and the removal electrode 44 face each other. The application electrode 42 is an electrode to which a removal power source 46 (one of the accessory units 80) applies a voltage V2 (positive potential) smaller than a voltage V1, described later, by about an order of magnitude. The removal electrode 44 is an electrode connected to the ground. Consequently, a weak electric field is generated between the application electrode 42 and the removal electrode 44 of the excess-electric-charge-removing unit 40. Of the electric charges 28 generated by the electric-charge generator 30, excess electric charges 28 that are not applied to the particulates 26 are accordingly attracted to the removal electrode 44 due to the weak electric field, are captured, and are released to the ground. Consequently, the excess-electric-charge-removing unit 40 inhibits the excess electric charges 28 from being collected by the collect electrode 54 of the collector 50 and from being counted as the number of the particulates 26. The application electrode 42 is connected to a terminal 43 (see FIG. 2) on the upper end portion 22b of the housing 22 with a wiring line that is disposed in the housing 22 and that is not illustrated interposed therebetween and is connected to the removal power source 46 with the terminal 43 interposed therebetween. The removal electrode 44 is connected to a terminal 45 (see FIG. 2) on the upper end portion 22b of the housing 22 with a wiring line that is disposed in the housing 22 and that is not illustrated interposed therebetween and is connected to the ground with the terminal 45 interposed therebetween.

As illustrated in FIG. 4, the collector 50 is disposed on the gas flow path 24 downstream of the electric-charge generator 30 and the excess-electric-charge-removing unit 40. The collector 50 collects the charged particulates P and includes an electric-field-generating electrode 52 and the collect electrode 54. The electric-field-generating electrode 52 is disposed along the inner surface of the right flow path wall 22d and is exposed to the inside of the gas flow path 24. The collect electrode 54 is disposed along the inner surface of the left flow path wall 22c and is exposed to the inside of the gas flow path 24. The electric-field-generating electrode 52 and the collect electrode 54 face each other. The electric-field-generating electrode 52 is an electrode to which a collect power source 56 (one of the accessory units 80) applies the voltage V1 (positive potential) larger than the voltage V2, which is applied to the application electrode 42. The collect electrode 54 is an electrode connected to the ground with an ammeter 62 interposed therebetween. Consequently, a relatively strong electric field is generated between the electric-field-generating electrode 52 and the collect electrode 54 of the collector 50. Accordingly, the charged particulates P that flow along the gas flow path 24 are attracted to the collect electrode 54 due to the relatively strong electric field and are collected. The electric-field-generating electrode 52 is connected to a terminal 53 (see FIG. 2) on the upper end portion 22b of the housing 22 with a wiring line that is disposed in the housing 22 and that is not illustrated interposed therebetween and is connected to the collect power source 56 with the terminal 53 interposed therebetween. The collect electrode 54 is connected to a terminal 55 (see FIG. 2) on the upper end portion 22b of the housing 22 with a wiring line that is disposed in the housing 22 and that is not illustrated interposed therebetween and is connected to the ammeter 62 with the terminal 55 interposed therebetween.

The size of the electrodes 42 and 44 of the excess-electric-charge-removing unit 40, the intensity of the electric field generated between the electrodes 42 and 44, the size of the electrodes 52 and 54 of the collector 50, and the intensity of the electric field generated between the electrodes 52 and 54 are set such that the charged particulates P are not collected by the removal electrode 44 but are collected by the collect electrode 54, and the electric charges 28 that are not applied to the particulates 26 are removed by the removal electrode 44. In general, the electrical mobility of the electric charges 28 is equal to or more than 10 times the electrical mobility of the charged particulates P. The electric field needed to collect the electric charges 28 is smaller than that to collect the charged particulates P by an order of magnitude or more. Accordingly, the above setting can be easily made. A plurality of the electric-field-generating electrodes 52 and a plurality of the collect electrodes 54 may be provided.

The number detection unit 60 is one of the accessory units 80 and includes the ammeter 62 and a number-measuring device 64 as illustrated in FIG. 4. A terminal of the ammeter 62 is connected to the collect electrode 54, and the other terminal thereof is connected to the ground. The ammeter 62 measures an electric current based on the electric charges 28 of the charged particulates P that are collected by the collect electrode 54. The number-measuring device 64 calculates the number of the particulates 26 on the basis of the electric current of the ammeter 62.

The heater electrode 72 is a belt-like heating element that is embedded in the housing 22. Specifically, the heater electrode 72 is disposed so as to extend from one of terminals 75 (see FIG. 2) on the upper end portion 22b of the housing 22, be drawn zigzag in the flow path wall 22c of the housing 22, and extend back to the other terminal 75 (see FIG. 2) on the upper end portion 22b of the housing 22. The heater electrode 72 is connected to a power supply device, not illustrated, with a pair of the terminals 75 interposed therebetween and generates heat when energized by the power supply device. The heater electrode 72 heats the housing 22 and the electrodes such as the removal electrode 44 and the collect electrode 54.

An example of use of the particulate detector 10 will now be described. When the particulates 26 contained in exhaust gas of an automobile are measured, the particulate-detecting element 20 is installed in the exhaust pipe 12 of the engine as described above (see FIG. 1).

As illustrated in FIG. 4, the particulates 26 contained in the exhaust gas that is introduced into the gas flow path 24 from the gas inlet 24a become the charged particulates P when charged with the electric charges 28 (here, positive electric charges) generated by electric discharge of the electric-charge generator 30. The charged particulates P pass through the excess-electric-charge-removing unit 40, at which the electric field is weak, which includes the removal electrode 44 the length of which is shorter than that of the collect electrode 54, and reach the collector 50. The electric charges 28 that are not applied to the particulates 26 are attracted to the removal electrode 44 of the excess-electric-charge-removing unit 40 even when the electric field is weak, pass through the removal electrode 44, and are released to the GND. Consequently, the unnecessary electric charges 28 that are not applied to the particulates 26 scarcely reach the collector 50.

The charged particulates P that reach the collector 50 are collected by the collect electrode 54 by using the electric field that is generated for collection by the electric-field-generating electrode 52. The ammeter 62 measures the electric current based on the electric charges 28 of the charged particulates P that are collected by the collect electrode 54. The number-measuring device 64 calculates the number of the particulates 26 on the basis of the electric current. The relationship between an electric current I and the quantity q of electric charge is that I=dq/(dt) and q=∫Idt. The number-measuring device 64 obtains an integrated value (accumulated electric charge amount) by integrating (adding up) the value of the electric current over a predetermined period of time, obtains the total number (the number of the collected electric charges) of the electric charges by dividing the accumulated electric charge amount by the elementary charge, and obtains the number Nt of the particulates 26 that are collected by the collect electrode 54 by dividing the number of the collected electric charges by the average value (average charge number) of the number of the electric charges that are applied to the single particulate 26 (see the following expression (1)). The number-measuring device 64 detects the number Nt as the number of the particulates 26 in the exhaust gas.

Nt=(accumulated electric charge amount)/{(elementary charge)×(average charge number)} (1)

As the particulate-detecting element 20 is used, and a large number of the particulates 26 and other substances are accumulated on the collect electrode 54, new charged particulates P are not collected by the collect electrode 54 in some cases. For this reason, the collect electrode 54 is heated by the heater electrode 72 when the amount of the accumulation reaches a predetermined amount or periodically so that the accumulation on the collect electrode 54 is heated and burned up to refresh an electrode surface of the collect electrode 54. The heater electrode 72 can also burn up the particulates 26 that adhere to the inner circumferential surface of the housing 22.

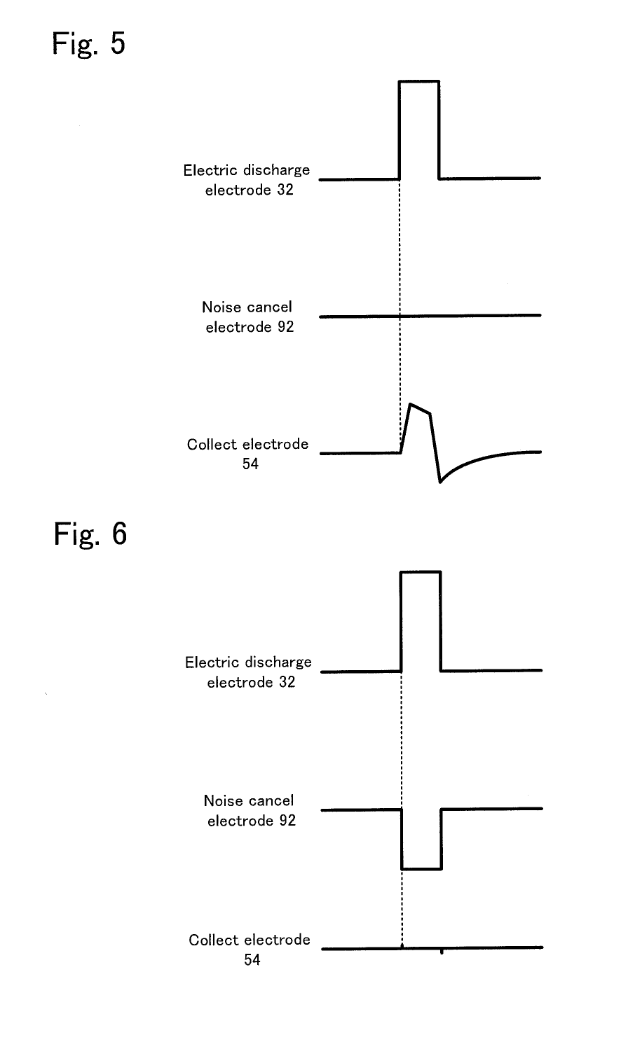

A noise signal that arrives at the collect electrode 54 will now be described. The present inventors investigated the noise signal that arrived at the collect electrode 54 when a pulse voltage of several kV was applied between the electric discharge electrode 32 and the two ground electrodes 34 of the electric-charge generator 30 so that the air discharge occurred before the particulate detector 10 was installed in the exhaust pipe 12. FIG. 5 is a graph illustrating variations in electrical signals of the electric discharge electrode 32, the noise cancel electrode 92, and the collect electrode 54 over time when the pulse voltage for the air discharge was applied to the electric-charge generator 30 with no pulse voltage applied to the noise canceller 90. FIG. 6 is a graph illustrating the variations in the electrical signals of the electric discharge electrode 32, the noise cancel electrode 92, and the collect electrode 54 over time when the pulse voltage for the air discharge was applied to the electric-charge generator 30 and a pulse voltage that had the polarity opposite the polarity of the pulse voltage and that had the same phase or substantially the same phase as the pulse voltage was applied to the noise canceller 90. In these graphs, the horizontal axis represents time, and the vertical axis represents voltage.

As clear from FIG. 5, in the case where no voltage was applied to the noise canceller 90, a relatively strong noise signal arrived at the collect electrode 54 because of the pulse voltage applied to the electric discharge electrode 32 of the electric-charge generator 30. As clear from FIG. 6, in the case where the pulse voltage for the air discharge was applied to the electric-charge generator 30, and the pulse voltage that had the polarity opposite the polarity of the pulse voltage and that had the same phase or substantially the same phase as the pulse voltage was applied to the noise canceller 90, the noise signal scarcely arrived at the collect electrode 54 even when the pulse voltage was applied to the electric discharge electrode 32 of the electric-charge generator 30. The magnitude of the absolute value of the pulse voltage applied to the noise canceller 90 was considered. Consequently, the noise signal was almost completely canceled even when the magnitude was smaller than the absolute value of the pulse voltage applied to the electric-charge generator 30. When the absolute value of the pulse voltage applied to the noise canceller 90 was equal to the absolute value of the pulse voltage applied to the electric-charge generator 30, a relatively weak noise signal that had the opposite polarity was made at the collect electrode 54.

In the particulate detector 10 described above, the noise canceller 90 cancels the noise that is made due to the electric discharge of the electric-charge generator 30. Such a noise affects a physical quantity (the detected electric current according to the present embodiment) that varies in response to the charged particulates P that are collected by the collect electrode 54, but is canceled here by the noise canceller 90. Consequently, the detected electric current of the collect electrode 54 can be grasped with high precision, and hence, the accuracy of the detection of the number of the particulates can be increased.

Since the pulse voltage that has the polarity opposite the polarity of the pulse voltage applied to the electric-charge generator 30 is applied to the noise canceller 90, the noise that is made due to the electric discharge of the electric-charge generator 30 can be effectively canceled. The pulse voltage that has the opposite polarity and that is applied to the noise canceller 90 preferably has the same phase as the pulse voltage applied to the electric-charge generator 30.

Since the noise canceller 90 is disposed between the electric-charge generator 30 and the collector 50, the noise cancel electrode 92 can be disposed near the collect electrode 54, and the noise can be canceled by using the pulse voltage that has the opposite polarity and that has a relatively small absolute value. In some cases, a negative electric charge (electric charge that has the polarity opposite the polarity of the electric charge generated by the electric-charge generator 30) is generated by electric discharge of the noise canceller 90. However, since the absolute value of the pulse voltage that has the opposite polarity is small, the quantity of the generated negative electric charge is small accordingly. Consequently, the positive electric charge of the charged particulates P can be inhibited from being canceled by the negative electric charge that is generated by the noise canceller 90 before the charged particulates P are collected by the collect electrode 54.

The noise cancel electrode 92 will now be further described. The position of the noise cancel electrode 92 and the voltage applied thereto are preferably determined in consideration of, for example, (1) prevention of dielectric breakdown between the electric discharge electrode 32 and the noise cancel electrode 92, (2) prevention of decrease in a noise cancel effect, and (3) prevention of the electric charge that has the opposite polarity and that is generated by the electric discharge of the noise cancel electrode 92. The electric discharge of the electric discharge electrode 32 occurs when the voltage applied thereto is 2 kV or more and occurs stably when the voltage applied thereto is 2.5 kV or more. In view of this, it is considered that the voltage applied to the electric discharge electrode 32 is set to, for example, 3 kV. In this case, the distance between the electric discharge electrode 32 and the noise cancel electrode 92 is increased to 1 mm or more (that is, the electric field strength is adjusted to 3 kV/mm or less) in order to prevent dielectric breakdown from occurring between the electric discharge electrode 32 and the noise cancel electrode 92. It is known that when the distance between the electric discharge electrode 32 and the noise cancel electrode 92 is too long, the electric field (electric lines of force) that is generated by the electric discharge electrode 32 is not canceled by the noise cancel electrode 92, makes a detour, and reaches the collect electrode 54, so that the noise cancel effect is decreased. Accordingly, the distance between the electric discharge electrode 32 and the noise cancel electrode 92 is preferably set such that the above (1) and (2) are satisfied in order to prevent the noise cancel effect from decreasing. The voltage applied to the noise cancel electrode 92 is preferably set to less than 2 kV for the above (3), that is, in order to prevent the electric charge that has the opposite polarity from being generated by the noise cancel electrode 92.

The present invention is not limited to the above-described embodiment, and can be carried out by various modes as long as they belong to the technical scope of the invention.

For example, although one of the ground electrodes 94 of the noise canceller 90 doubles as one of the ground electrodes 34 of the electric-charge generator 30 according to the above embodiment, the ground electrode 34 and the ground electrode 94 may be separately provided. In the case where the ground electrode 94 doubles as the ground electrode 34, the number of the electrodes decreases, and component costs and manufacturing costs decrease.

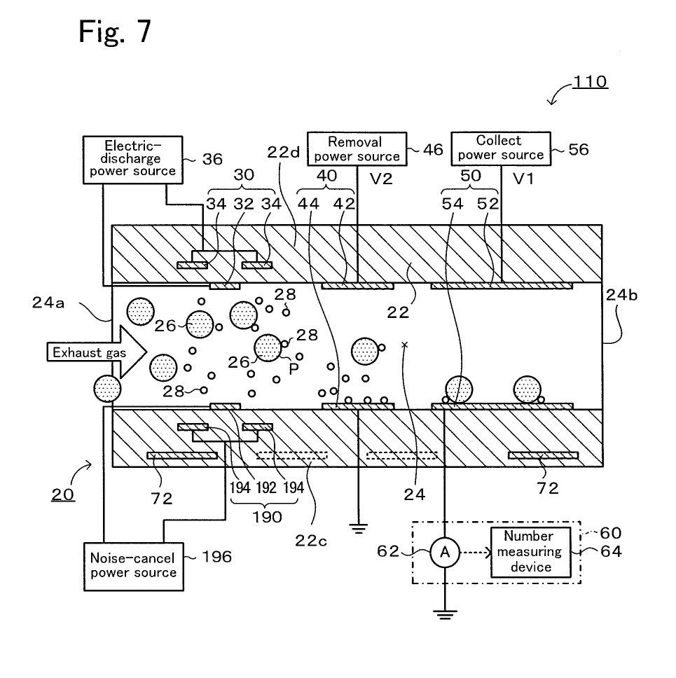

According to the above embodiment, the noise canceller 90 is disposed between the electric-charge generator 30 and the collector 50 (more specifically, between the electric-charge generator 30 and the excess-electric-charge-removing unit 40). However, the position of the noise canceller 90 is not particularly limited thereto. For example, as with a particulate detector 110 in FIG. 7, a noise canceller 190 may be disposed so as to face the electric-charge generator 30. The noise canceller 190 includes a noise cancel electrode 192 that is disposed on the wall surface of the flow path wall 22c and two ground electrodes 194 that are embedded in the flow path wall 22c. In FIG. 7, components like to those according to the above embodiment are designated by like reference numbers. In the case where the noise cancel electrode 92 is disposed near the collect electrode 54, and the electric discharge electrode 32 is disposed far from the collect electrode 54, the absolute value of the pulse voltage to the noise cancel electrode 92 can be decreased, and the electric charge that has the opposite polarity and that is generated by the noise cancel electrode 92 can be reduced. For this reason, in FIG. 7, the noise canceller 190 is disposed in the left flow path wall 22c, on which the collect electrode 54 is also disposed, and the electric-charge generator 30 is disposed on the right flow path wall 22d. The electric discharge electrode 32 and the noise cancel electrode 192 face each other. Accordingly, the length of the gas flow path 24 can be shorter than that in the case where the noise canceller 90 is disposed in the same surface as the electric-charge generator 30 as with the above embodiment.

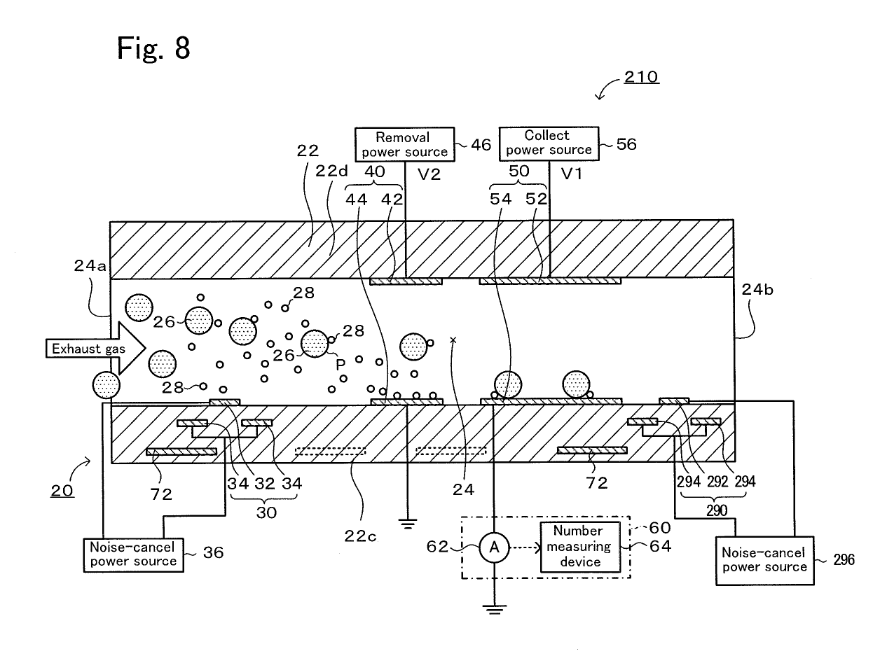

Alternatively, as with a particulate detector 210 in FIG. 8, a noise canceller 290 may be disposed downstream of the collector 50 in the direction of flow of the gas. The noise canceller 290 includes a noise cancel electrode 292 that is disposed on the wall surface of the flow path wall 22c and two ground electrodes 294 that are embedded in the flow path wall 22c. In FIG. 8, components like to those according to the above embodiment are designated by like reference numbers. In the particulate detector 210, the positive electric charge of the charged particulates P is scarcely canceled by the negative electric charge that is generated by the noise canceller 290 before the charged particulates P are collected by the collector 50.

According to the above embodiment, the noise canceller 90 includes the noise cancel electrode 92 that is disposed along the inner surface of the flow path wall 22c of the gas flow path 24 and the two ground electrodes 94 that are embedded in the flow path wall 22c. However, the noise canceller 90 may have any structure provided that the noise due to the electric discharge of the electric-charge generator 30 can be canceled. For example, the ground electrodes 94 may not be embedded in the flow path wall 22c but may be disposed along the inner surface of the flow path wall 22c.

According to the above embodiment, the electric-charge generator 30 includes the electric discharge electrode 32 that is disposed along the inner surface of the flow path wall 22c of the gas flow path 24 and the two ground electrodes 34 that are embedded in the flow path wall 22c. However, the electric-charge generator 30 may have any structure provided that the electric charge is generated by air discharge. For example, the ground electrodes 34 may not be embedded in the flow path wall 22c but may be disposed along the inner surface of the flow path wall 22c. Alternatively, as disclosed in PTL 1, the electric-charge generator may include a needle-shaped electrode and a facing electrode.

According to the above embodiment, the electric-field-generating electrode 52 is exposed to the gas flow path 24. However, the electric-field-generating electrode 52 is not limited thereto and may be embedded in the housing 22. A pair of electric-field-generating electrodes may be disposed in the housing 22 so as to interpose the collect electrode 54 therebetween in the vertical direction instead of the electric-field-generating electrode 52, the charged particulates P may be moved toward the collect electrode 54 by using an electric field that is generated by applying a voltage between the pair of the electric-field-generating electrodes. The same is true for the application electrode 42.

According to the above embodiment, the voltage V1 is applied to the electric-field-generating electrode 52. However, even when no voltage is applied thereto, and no electric field is generated by the electric-field-generating electrode 52, the charged particulates P each of which has a relatively small particle diameter and undergoes Brownian motion violently can be collided against the collect electrode 54 in a manner in which the width of the gas flow path 24 in the left-right direction is set to a very small value (for example, 0.01 mm or more and less than 0.2 mm). This enables the collect electrode 54 to collect the charged particulates P. In this case, the particulate-detecting element 20 may not include the electric-field-generating electrode 52.

In an example described according to the above embodiment, the particulate detector 10 is installed in the exhaust pipe 12 of the engine. However, the exhaust pipe 12 of the engine is not a limitation. Any pipe is acceptable provided that gas containing particulates passes through the pipe.

According to the above embodiment, the particulate-detecting element 20 detects the number of the particulates. However, the particulate-detecting element 20 may detect the mass or surface area of the particulates. The mass of the particulates can be obtained, for example, by multiplying the number of the particulates by the average mass of the particulates. Alternatively, the relationship between the accumulated electric charge amount and the mass of the particulates collected is stored as a map in a storage device in advance, and the mass of the particulates can be obtained from the accumulated electric charge amount by using the map. The surface area of the particulates can be obtained in the same manner as in the mass of the particulates.

According to the above embodiment, the excess-electric-charge-removing unit 40 is provided. However, the excess-electric-charge-removing unit 40 may not be provided.

According to the above embodiment, the number of the charged particulates P is obtained on the basis of the electric current that flows into the collect electrode 54. However, the number of the charged particulates P may be obtained by obtaining the number of the excess electric charges on the basis of the electric current that flows into the removal electrode 44, and subtracting the number of the excess electric charges from the total number of the electric charges that are generated by the electric-charge generator 30. In this case, the excess-electric-charge-removing unit 40 corresponds to the collector of the particulate detector according to the present invention, and each excess electric charge corresponds to the object to be collected. The collector 50 may not be provided.

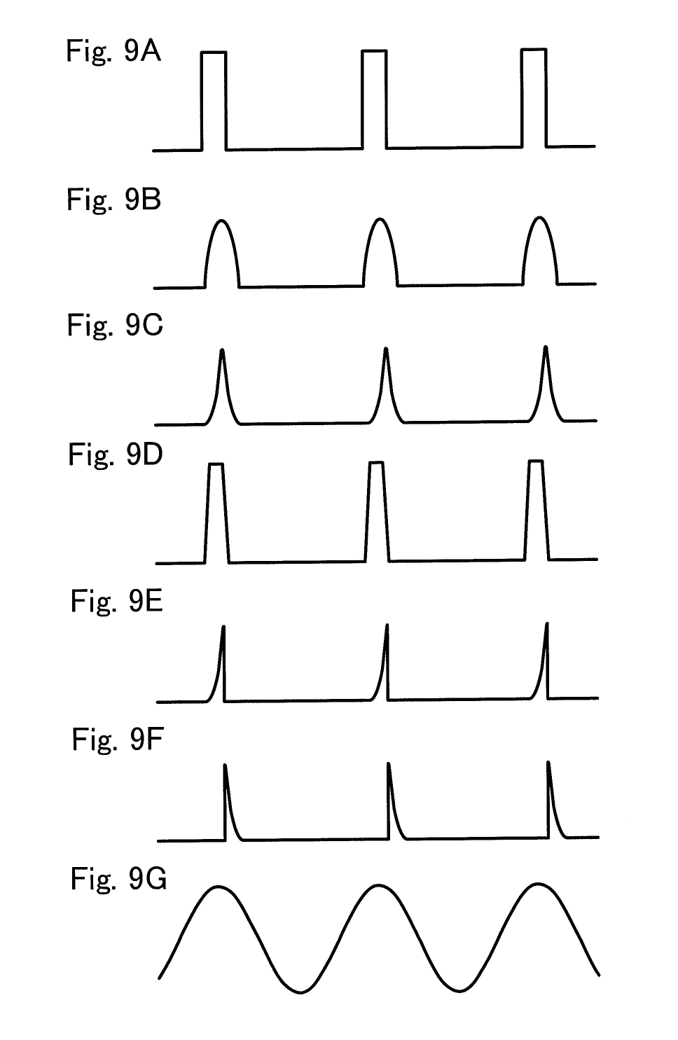

According to the above embodiment, a square wave pulse voltage is used. However, the shape of the pulse voltage is not limited to a rectangular shape and can be selected from various shapes such as a trapezoid shape, a triangle shape, and a saw tooth shape. A sinusoidal voltage may be used instead of the pulse voltage. Representative examples of the shape of the pulse voltage are illustrated in FIGS. 9A to 9F. A representative example of the shape of the sinusoidal voltage is illustrated in FIG. 9G.

The present application claims priority of Japanese Patent Application No. 2018-051051 filed on Mar. 19, 2018, the entire contents of which are incorporated herein by reference.

What is claimed is:

1. A particulate detector that is used to detect a particulate in gas, the particulate detector comprising:
a housing having a gas flow path through which the gas passes;
an electric-charge generator that applies an electric charge generated by electric discharge to the particulate in the gas that is introduced into the gas flow path to obtain a charged particulate;
a collector that is disposed on the gas flow path downstream of the electric-charge generator in a direction of flow of the gas and that collects, as an object to be collected, the charged particulate or an excess electric charge that is not applied to the particulate;
a noise canceller that cancels a noise that is made due to the electric discharge of the electric-charge generator; and
a detection unit that detects an amount of the particulate on the basis of a physical quantity that varies in response to the object collected by the collector.

2. The particulate detector according to claim 1,
wherein a sinusoidal voltage or a pulse voltage for the electric discharge is applied to the electric-charge generator, and
a sinusoidal voltage or a pulse voltage that has a polarity opposite a polarity of the sinusoidal voltage or the pulse voltage is applied to the noise canceller.

3. The particulate detector according to claim 1,
wherein the noise canceller is disposed between the electric-charge generator and the collector.

4. The particulate detector according to claim 2,
wherein the noise canceller is disposed between the electric-charge generator and the collector.

5. The particulate detector according to claim 1,
wherein the noise canceller is disposed so as to face the electric-charge generator.

6. The particulate detector according to claim 2,
wherein the noise canceller is disposed so as to face the electric-charge generator.

7. The particulate detector according to claim 1,
wherein the noise canceller is disposed downstream of the collector in the direction of the flow of the gas.

8. The particulate detector according to claim 2,
wherein the noise canceller is disposed downstream of the collector in the direction of the flow of the gas.

9. The particulate detector according to claim 1,
wherein the collector collects the charged particulate as the object to be collected, and
an excess-electric-charge-removing unit that removes the excess electric charge is disposed between the electric-charge generator and the collector.

10. The particulate detector according to claim 2,
wherein the collector collects the charged particulate as the object to be collected, and
an excess-electric-charge-removing unit that removes the excess electric charge is disposed between the electric-charge generator and the collector.
